(19) United States
(12) Patent Application Publication
(10) Pub. No.: US 2023/0386686 A1
(43) Pub. Date: Nov. 30, 2023

(54) NUCLEAR REACTOR

(71) Applicant: MITSUBISHI HEAVY INDUSTRIES, LTD., Tokyo (JP)

(72) Inventors: Nozomu Murakami, Tokyo (JP); Wataru Nakazato, Tokyo (JP); Takashi Hasegawa, Tokyo (JP); Satoru Kamohara, Tokyo (JP); Yasutaka Harai, Tokyo (JP); Tadakatsu Yodo, Tokyo (JP); Shota Kobayashi, Tokyo (JP); Shohei Otsuki, Tokyo (JP); Yutaka Tanaka, Tokyo (JP); Tatsuo Ishiguro, Tokyo (JP); Hironori Noguchi, Tokyo (JP); Hideyuki Kudo, Tokyo (JP); Takafumi Noda, Tokyo (JP); Kazuhiro Yoshida, Tokyo (JP)

(73) Assignee: MITSUBISHI HEAVY INDUSTRIES, LTD., Tokyo (JP)

(21) Appl. No.: 18/031,766

(22) PCT Filed: Sep. 21, 2021
(86) PCT No.: PCT/JP2021/034615

§ 371 Date: Apr. 13, 2023

(30) Foreign Application Priority Data
Oct. 16, 2020 (JP) 2020-174674

(51) Int. Cl. G21C 1/32; G21C 15/10; G21C 3/36

(52) U.S. Cl. CPC G21C 1/32; G21C 15/10; G21C 3/36

(57) ABSTRACT

An object is to efficiently take heat out of a reactor core while retaining fission products. Included are fuel part provided with a covering part on a surface of a nuclear fuel and a heat conductive part.

### FIELD

The present disclosure relates to a nuclear reactor.

### BACKGROUND

Patent Literature 1 and 2 show structures in which fuel of a reactor core is formed in a disc-shaped layer, for example.

### CITATION LIST

### Patent Literature

Patent Literature 1: Japanese Patent Application Laid-open No. S62-17689
Patent Literature 2: Japanese Patent Application Laid-open No. H05-45485

### SUMMARY

### Technical Problem

In nuclear reactors, it is desirable to retain fission products (FP) discharged by the fission of nuclear fuel materials inside a nuclear reactor vessel and to efficiently take heat out of the reactor core of the nuclear reactor including the nuclear fuel materials.

The present disclosure solves the problem described above, and an object thereof is to provide a nuclear reactor that can efficiently take heat out of a reactor core while retaining fission products inside a nuclear reactor vessel.

### Solution to Problem

To achieve the object, a nuclear reactor according to one aspect the present disclosure includes a fuel part provided with a covering part on a surface of a nuclear fuel; and a heat conductive part.

### Advantageous Effects of Invention

The present disclosure can efficiently take heat out of a reactor core while retaining fission products.

### BRIEF DESCRIPTION OF DRAWINGS

FIG. 1 is a schematic diagram of a nuclear power generation system including a nuclear reactor according to embodiments.

FIG. 2 is a schematic diagram of the nuclear reactor according to a first embodiment.

FIG. 3 is a sectional schematic diagram of the nuclear reactor according to the first embodiment.

FIG. 4 is a sectional schematic diagram of another example of the nuclear reactor according to the first embodiment.

FIG. 5 is a partially cutaway enlarged schematic diagram of the nuclear reactor according to the first embodiment.

FIG. 6 is a partially cutaway enlarged schematic diagram of the nuclear reactor according to the first embodiment.

FIG. 7 is a partially cutaway enlarged schematic diagram of the nuclear reactor according to the first embodiment.

FIG. 8 is a partially cutaway enlarged schematic diagram of the nuclear reactor according to the first embodiment.

FIG. 9 is a sectional schematic diagram of a fuel part of the nuclear reactor according to the first embodiment.

FIG. 10 is a schematic perspective view of the fuel part of the nuclear reactor according to the first embodiment.

FIG. 11 is a schematic perspective view of another example of the fuel part of the nuclear reactor according to the first embodiment.

FIG. 12 is a schematic perspective view of another example of the fuel part of the nuclear reactor according to the first embodiment.

FIG. 13 is a sectional schematic diagram of another example of nuclear fuel of the nuclear reactor according to the first embodiment.

FIG. 14 is a schematic perspective view of another example of the fuel part of the nuclear reactor according to the first embodiment.

FIG. 15 is a schematic diagram of a nuclear reactor according to a second embodiment.

FIG. 16 is a sectional schematic diagram of the nuclear reactor according to the second embodiment.

FIG. 17 is a schematic diagram of another form of the nuclear reactor according to the second embodiment.

FIG. 18 is an enlarged schematic diagram of a heat conductive part of the nuclear reactor according to the second embodiment.

FIG. 19 is a schematic diagram of another form of the nuclear reactor according to the second embodiment.

FIG. 20 is an illustrative diagram of the form illustrated in FIG. 18.

FIG. 21 is a schematic diagram of a nuclear reactor according to a third embodiment.

### DESCRIPTION OF EMBODIMENTS

The following describes embodiments according to the present disclosure in detail based on the accompanying drawings. This invention is not limited by these embodiments. The constituent elements in the following embodiment include a constituent element that is replaceable by those skilled in the art and is easy, or substantially the same constituent element.

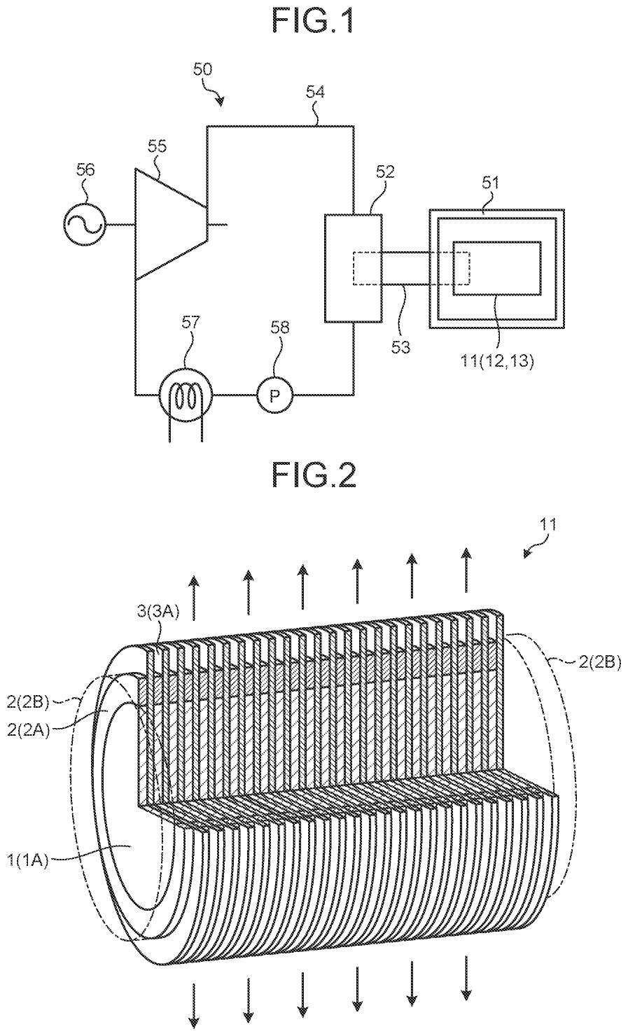

FIG. 1 is a schematic diagram of a nuclear power generation system including a nuclear reactor according to embodiments. As illustrated in FIG. 1, this nuclear power generation system 50 has a nuclear reactor vessel 51, a heat exchanger 52, a heat conductive part 53, a coolant circulating unit 54, a turbine 55, a power generator 56, a cooler 57, and a compressor 58.

The nuclear reactor vessel 51 has a nuclear reactor 11 (12 or 13) of the embodiments, which are described below. The nuclear reactor vessel 51 houses the nuclear reactor 11 (12 or 13) thereinside. The nuclear reactor vessel 51 houses the nuclear reactor 11 (12 or 13) in a hermetically sealed condition. The nuclear reactor vessel 51 is provided with an opening and closing part such as a lid such that the nuclear reactor 11 (12 or 13) placed thereinside can be housed or taken out. The nuclear reactor vessel 51 can maintain its hermetically sealed condition even when a nuclear fission reaction occurs in the nuclear reactor 11 (12 or 13) to make the inside high temperature and high pressure. The nuclear reactor vessel 51 is formed of a material having neutron beam blocking performance.

The heat exchanger 52 performs heat exchange with the nuclear reactor 11 (12 or 13). The heat exchanger 52 of the embodiments recovers the heat of the nuclear reactor 11 (12 or 13) via a solid, highly heat conductive material of the heat conductive part 53 partially placed inside the nuclear reactor vessel 51. The heat conductive part 53 illustrated in FIG. 1 collectively refers to and schematically illustrates heat conductive parts 3, 103, and 104, which are described below.

The coolant circulating unit 54 is a path through which a coolant is circulated, in which the heat exchanger 52, the turbine 55, the cooler 57, and the compressor 58 are connected to each other. The coolant flowing through the coolant circulating unit 54 flows through the heat exchanger 52, the turbine 55, the cooler 57, and the compressor 58 in this order, and the coolant having passed through the compressor 58 is supplied to the heat exchanger 52. Consequently, the heat exchanger 52 performs heat exchange between the solid, highly heat conductive material of the heat conductive part 53 and the coolant flowing through the coolant circulating unit 54.

The coolant having passed through the heat exchanger 52 flows into the turbine 55. The turbine 55 is rotated by the energy of the heated coolant. In other words, the turbine 55 converts the energy of the coolant into rotational energy to absorb the energy from the coolant.

The power generator 56 is coupled to the turbine 55 and rotates integrally with the turbine 55. The power generator 56 rotates with the turbine 55 to perform power generation.

The cooler 57 cools the coolant having passed through the turbine 55. The cooler 57 is a chiller or a condenser or the like when the coolant is temporarily liquefied.

The compressor 58 is a pump pressurizing the coolant.

The nuclear power generation system 50 conducts heat generated through the reaction of nuclear fuel of the nuclear reactor 11 (12 or 13) to the heat exchanger 52 by the heat conductive part 53. The nuclear power generation system 50 heats the coolant flowing through the coolant circulating unit 54 by the heat of the highly heat conductive material of the heat conductive part 53 in the heat exchanger 52. In other words, the coolant absorbs heat in the heat exchanger 52. The heat generated in the nuclear reactor 11 (12 or 13) is thereby recovered by the coolant. The coolant is compressed by the compressor 58 and is then heated when passing through the heat exchanger 52 to rotate the turbine 55 by compressed and heated energy. The coolant is then cooled to a standard state by the cooler 57 and is again supplied to the compressor 58.

As described above, the nuclear power generation system 50 conducts the heat taken out of the nuclear reactor 11 (12 or 13) to the coolant as a medium rotating the turbine 55 via the highly heat conductive material. The nuclear reactor 11 (12 or 13) and the coolant as the medium rotating the turbine 55 can be thereby isolated from each other, and the risk of the medium rotating the turbine 55 being polluted can be reduced.

### First Embodiment

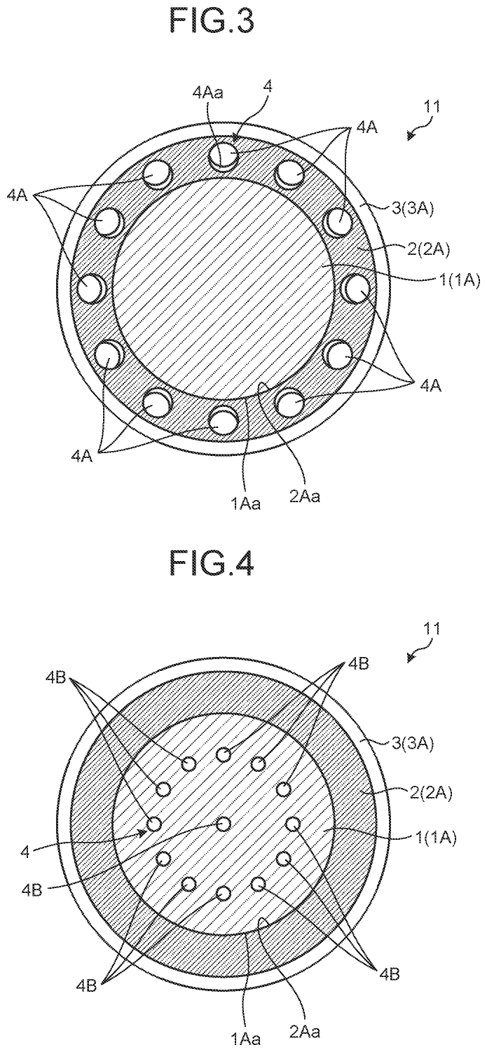

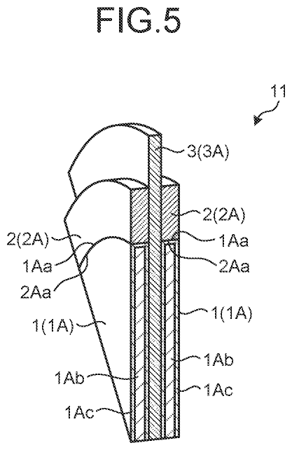

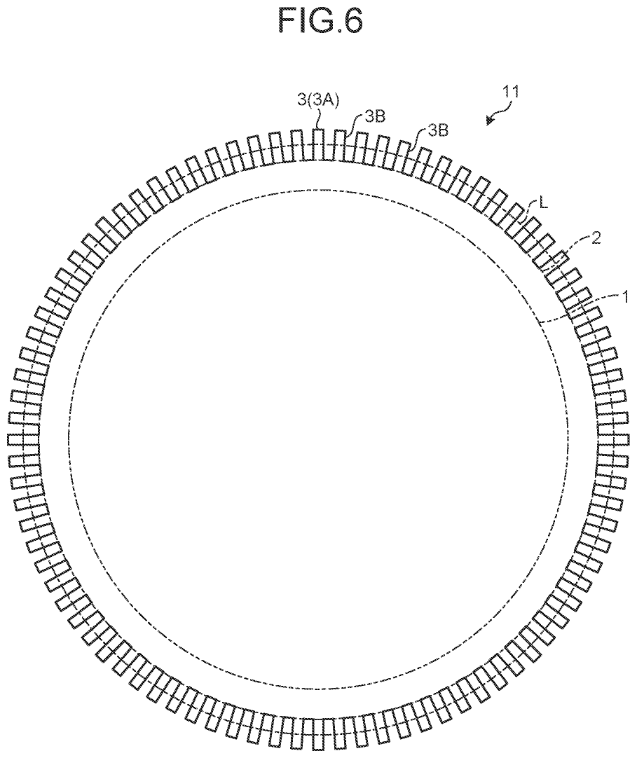

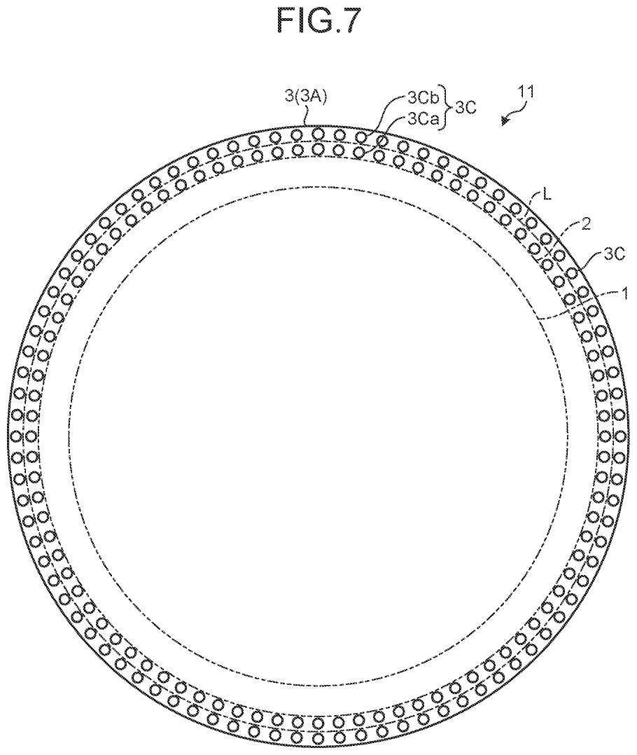

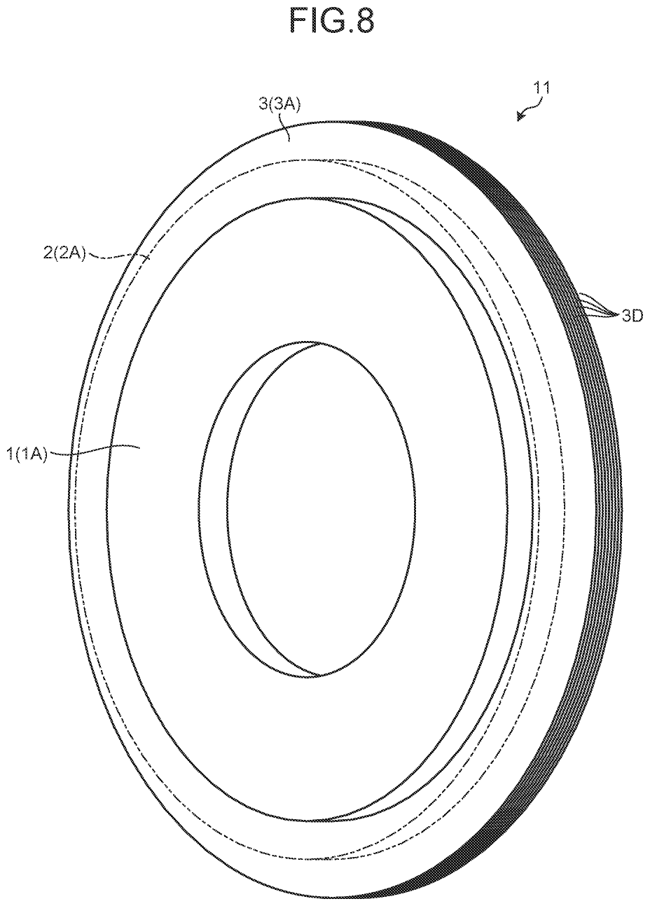

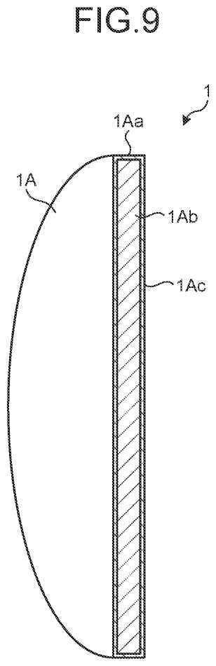

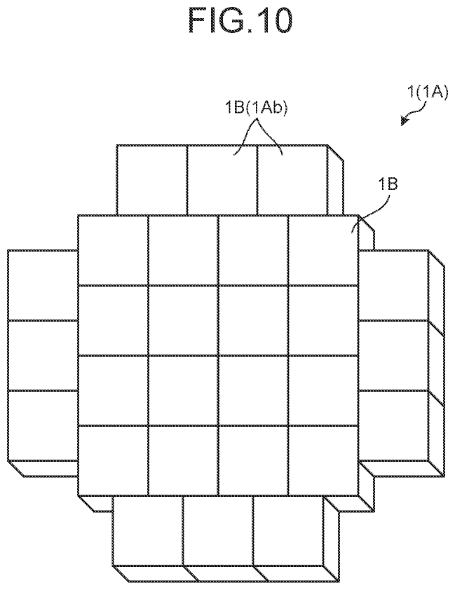

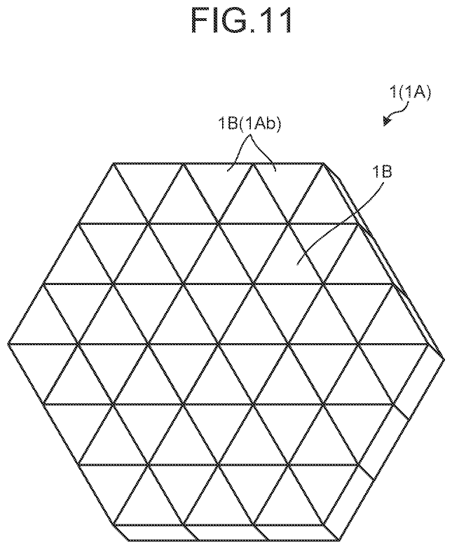

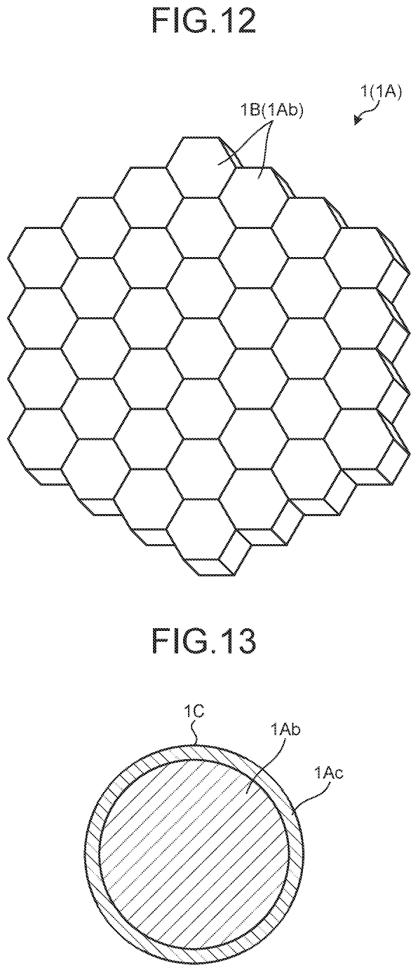

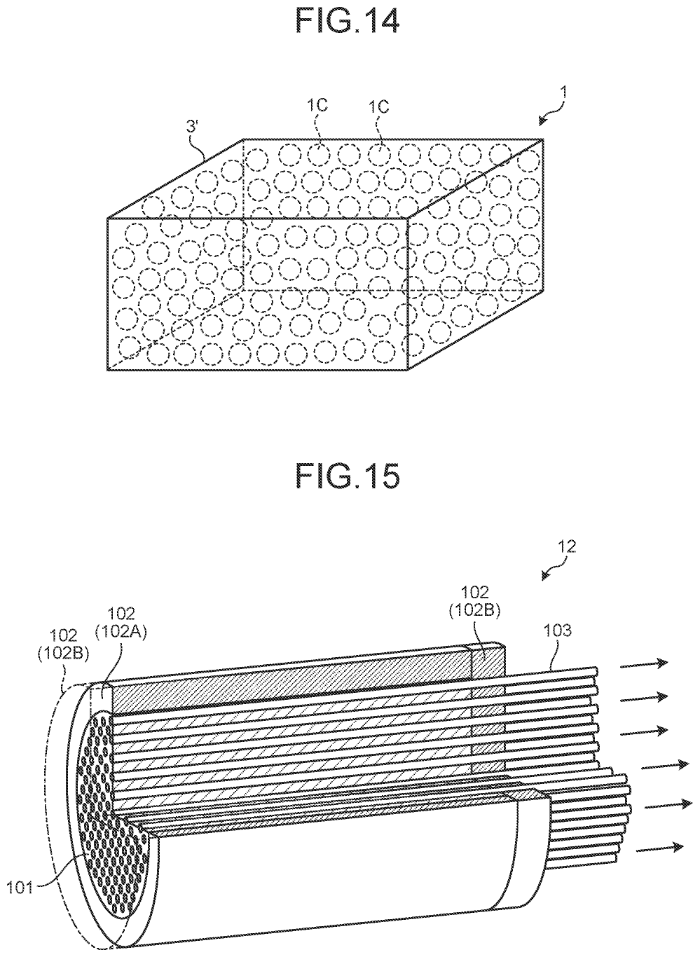

FIG. 2 is a schematic diagram of the nuclear reactor according to a first embodiment. FIG. 3 is a sectional schematic diagram of the nuclear reactor according to the first embodiment. FIG. 4 is a sectional schematic diagram of another example of the nuclear reactor according to the first embodiment. FIG. 5 is a partially cutaway enlarged schematic diagram of the nuclear reactor according to the first embodiment. FIG. 6 is a partially cutaway enlarged schematic diagram of the nuclear reactor according to the first embodiment. FIG. 7 is a partially cutaway enlarged schematic diagram of the nuclear reactor according to the first embodiment. FIG. 8 is a partially cutaway enlarged schematic diagram of the nuclear reactor according to the first embodiment. FIG. 9 is a sectional schematic diagram of a fuel part of the nuclear reactor according to the first embodiment. FIG. 10 is schematic perspective view of the fuel part of the nuclear reactor according to the first embodiment. FIG. 11 is a schematic perspective view of another example of the fuel part of the nuclear reactor according to the first embodiment. FIG. 12 is a schematic perspective view of another example of the fuel part of the nuclear reactor according to the first embodiment. FIG. 13 is a sectional schematic diagram of another example of nuclear fuel of the nuclear reactor according to the first embodiment. FIG. 14 is a schematic perspective view of another example of the fuel part of the nuclear reactor according to the first embodiment.

As illustrated in FIG. 2 to FIG. 5, the nuclear reactor 11 includes a fuel part (a reactor core) 1, a shielding part 2, the heat conductive parts 3, and a control mechanism 4.

The fuel part 1 has a fuel layer 1A formed in a plate shape. The fuel layer 1A in the first embodiment is formed in a disc shape. A plurality of the fuel layers 1A are provided and are placed in an aligned manner such that their plate faces face each other. The direction in which the fuel layers 1A are aligned with the plate faces facing each other may be referred to as an axial direction. The fuel layers 1A contain uranium as a nuclear fuel material.

The shielding part 2 covers the periphery of the fuel part 1. The shielding part 2 includes a metallic block, for example, and reflects radiation (neutrons) applied from the nuclear fuel to prevent the radiation from being leaked to the outside covering the fuel part 1. The shielding part 2 may be called a reflector in accordance with the ability of neutron scattering and neutron absorption of the used material. The shielding part 2 has a shielding layer 2A. The shielding layer 2A is formed in a plate shape covering the periphery of the fuel layer 1A along a peripheral face 1Aa of the fuel layer 1A. The shielding layer 2A has a through hole 2Aa passing across plate-shaped both plate faces to be formed in an annular shape (a ring shape). The shielding part 2 houses the fuel layer 1A in the through hole 2Aa.

The shielding part 2 has lids 2B formed in a plate shape so as to cover the fuel part 1 provided at both ends in the axial direction. The shielding part 2 houses the fuel part 1 in the hermetically sealed inside by the shielding layers 2A and the lids 2B. In housing the fuel part 1 inside, it is preferable that the inside with the hermetically sealed structure be filled with an inert gas such as a nitrogen gas for the purpose of preventing oxidation inside.

The heat conductive part 3 has a heat conductive layer 3A formed in a plate shape. The heat conductive layers 3A are placed such that their plate faces are stacked in the axial direction to be in contact with the plate faces of the fuel layers 1A. The heat conductive layer 3A is formed to have a larger outer diameter than those of the fuel layer 1A and the shielding layer 2A to protrude around the periphery of the fuel layer 1A and the shielding layer 2A. The heat conductive layer 3A of the first embodiment is formed in a disc shape and is provided protruding from the entire periphery of the fuel layer 1A and the shielding layer 2A in a radial direction. The radial direction is a direction orthogonal to the stacking direction (the axial direction). The heat conductive layers 3A are alternately stacked on the fuel layers 1A of the fuel part 1 in the axial direction and are provided extending from the inside to the outside of the hermetically sealed shielding part 2. The heat conductive layer 3A conducts the heat generated by the nuclear fission reaction of the nuclear fuel of the fuel layer 1A to the outside of the shielding layer 2A by solid heat conduction. For the heat conductive layer 3A, titanium, nickel, copper, or graphite can be used, for example. For graphite, graphene in particular can be used. Graphene has a structure in which hexagonal lattices including carbon atoms and their bonding continue, and the direction in which the hexagonal lattices continue is set to a heat conduction direction, whereby heat conduction efficiency can be improved. The heat conductive layer 3A is provided with a part extending outside the shielding layer 2A so as to be able to perform heat exchange with the coolant inside the nuclear reactor vessel 51.

The control mechanism 4 is placed in the shielding part 2 outside the fuel layer 1A in the radial direction. The control mechanism 4 of the first embodiment is configured as control drums 4A as illustrated in FIG. 3. The control drums 4A are cylindrical and are formed in what is called a drum shape. The control drums 4A are each formed by a cylinder extending in the axial direction of the nuclear reactor 11. The control drums 4A are provided passing through the shielding part 2 and the heat conductive parts 3 in the axial direction. A plurality of (12 in the first embodiment) control drums 4A are placed evenly in a circumferential direction, which is around the axial direction of the nuclear reactor 11. The control drums 4A are provided so as to be rotatable around the cylinder. The control drums 4A are each provided with a neutron absorber 4Aa in part of the periphery of the cylinder. The neutron absorber 4Aa is provided at a position at least facing the peripheral face 1Aa of the fuel layer 1A, and boron carbide (B₄C) can be used, for example. The neutron absorber 4Aa rotates and moves with the rotation of the control drums 4A to move closer to or away from the peripheral face 1Aa of the fuel part 1 as the reactor core. When the neutron absorber 4Aa moves closer to the fuel part 1, the reactivity of the fuel part 1 decreases, whereas when the neutron absorber 4Aa moves away from the fuel part 1, the reactivity of the fuel part 1 increases. Thus, the control drums 4A cause the neutron absorber 4Aa to move closer to or away from the fuel part 1 by rotation and can thereby control the reactivity of the fuel part 1 as the reactor core and control the reactor core temperature of the fuel part 1. The reactor core temperature is an average reactor core temperature taken out of the shielding part 2 by the heat conductive parts 3. The control drums 4A have a drive unit, which is not illustrated, that drives their rotation. The drive unit is configured such that rotation is urged so that the neutron absorber 4Aa of the control drums 4A moves closer to the inner face of the fuel part 1, and the neutron absorber 4Aa automatically moves closer to the peripheral face 1Aa of the fuel part 1 when the coupling with the control drums 4A is cut off by a clutch mechanism or the like. Thus, in an emergency when the temperature of the fuel part 1 becomes a set temperature or higher, for example, the neutron absorber 4Aa can automatically move closer to the inner face of the fuel part 1 to reduce the reactivity of the fuel part 1.

The control mechanism 4 is not limited to the control drums 4A and may also be control rods 4B as illustrated in FIG. 4. A plurality of control rods 4B are provided passing through the fuel part 1 and the heat conductive parts 3 in the axial direction. The control rods 4B are formed in a rod shape. The control rods 4B are formed extending in the axial direction of the nuclear reactor 11. The control rods 4B are provided so as to be slidable in the axial direction. The control rods 4B are formed of a neutron absorber. For the neutron absorber, boron carbide (B₄C) can be used, for example. The control rods 4B are provided such that they can move closer to or away from the fuel part 1 as the reactor core by moving in the axial direction by sliding and being inserted into the tubular shape of the fuel part 1 or being pulled out of the tubular shape of the fuel part 1. When the control rods 4B are inserted into the fuel part 1, the reactivity of the fuel part 1 decreases, and when the control rods 4B are pulled out of the fuel part 1, the reactivity of the fuel part 1 increases. Thus, the control rods 4B insert or pull the neutron absorber into or out of the fuel part 1 by sliding and can thereby control the reactivity of the fuel part 1 as the reactor core and control the reactor core temperature of the fuel part 1. The control rods 4B have a drive unit, which is not illustrated, that drives their sliding. The drive unit urges sliding so that the control rods 4B are inserted to the inner face of the fuel part 1 and automatically inserts the control rods 4B into the fuel part 1 when the coupling with the control rods 4B is cut off by a clutch mechanism or the like. Thus, in an emergency when the temperature of the fuel part 1 becomes a set temperature or higher, for example, the control rods 4B can be automatically inserted into the fuel part 1 to reduce the reactivity of the fuel part 1.

Consequently, the nuclear reactor 11 of the first embodiment can take the heat generated by the nuclear fission reaction of the nuclear fuel of the fuel part 1 out of the shielding part 2 by solid heat conduction by the heat conductive parts 3. The heat having been taken out of the shielding part 2 is then conducted to the coolant, which rotates the turbine 55.

The nuclear reactor 11 of the first embodiment can take the heat of the nuclear fuel of the fuel part 1 out of the shielding part 2 by solid heat conduction by the heat conductive parts 3 (refer to the arrows in FIG. 2) and conduct the heat to the coolant. Consequently, the nuclear reactor 11 of the first embodiment can prevent leakage of radioactive materials or the like. In the nuclear reactor 11 of the first embodiment, the heat conductive parts 3 are placed extending inside the fuel part 1 and outside the shielding part 2 and can thus take the heat of the nuclear fuel of the fuel part 1 out of the shielding part 2 while reducing the conduction distance of the heat compared to a case in which the heat conductive parts 3 are not inside. Consequently, the nuclear reactor 11 of the first embodiment can ensure high output temperature. Although the nuclear reactor 11 of the first embodiment describes the heat conductive parts 3 in the form of taking out heat by solid heat conduction, other heat conductive parts in the form of taking out heat by fluid heat conduction using a liquid-encapsulated heat pipe may be used, for example.

In the nuclear reactor 11 of the first embodiment, the fuel layer 1A of the fuel part 1 and the heat conductive layer 3A of the heat conductive part 3 are formed in a plate shape and are placed alternately stacked on each other with the plate faces facing each other, and the plate-shaped heat conductive layer 3A is placed with its plate-shaped peripheral part extending outside the shielding part 2. Consequently, the nuclear reactor 11 of the first embodiment can be a form in which the heat conductive part 3 is placed passing through the shielding part 2 to extend inside the fuel part 1 and outside the shielding part 2, and the heat of the fuel part 1 can be taken out of the shielding part 2 by solid heat conduction. A plurality of plate shapes of the fuel layer 1A and a plurality of plate shapes of the heat conductive layer 3A may be changed in plate thickness. Covering the outside of the shielding part 2 from which the heat conductive part 3 does not extend with a heat insulating material can improve the efficiency of heat recovery by the heat conductive part 3.

In the nuclear reactor 11 of the first embodiment, as illustrated in FIG. 6, it is preferable that the heat conductive part 3 is formed with a plurality of cutouts 3B in the part of each heat conductive layer 3A extending outside the shielding part 2. The cutouts 3B are formed extending in the radial direction away from the outer face of the shielding part 2 and are formed in a line around the periphery of the heat conductive part 3 along the periphery of the shielding part 2. That is, the heat conductive part 3 is formed with gaps allowing the coolant to pass therethrough by the cutouts 3B in the part extending outside the shielding part 2, the part performing heat exchange with the coolant circulating through the coolant circulating unit 54 in order to perform heat exchange by the heat exchanger 52. Consequently, the nuclear reactor 11 of the first embodiment can increase the efficiency of conducting the heat taken out by the heat conductive part 3 to the coolant.

In the heat conductive part 3 formed extending in the radial direction away from the outer face of the shielding part 2, the heat taken out is higher on the inside in the radial direction close to the fuel part 1 and lower on the outside in the radial direction far from the fuel part 1. In FIG. 6, for example, when the heat conductive part 3 formed extending in the radial direction away from the outer face of the shielding part 2 is divided into two regions in the radial direction by an imaginary line L, the temperature of the heat taken out is higher inside the imaginary line L in the radial direction than outside in the radial direction. Given this, in performing heat exchange with the coolant in the heat conductive part 3, the coolant is first passed outside the imaginary line L in the radial direction, then returned, and passed inside the imaginary line L in the radial direction, and the coolant is then sent out to the heat exchanger 52. In this way, the efficiency of conducting the heat taken out by the heat conductive part 3 to the coolant can be increased.

In the nuclear reactor 11 of the first embodiment, as illustrated in FIG. 7, it is preferable that the heat conductive part 3 is passed through by heat conductive tubes 3C through which the coolant is circulated in the part of each heat conductive layer 3A extending outside the shielding part 2. The heat conductive tubes 3C are formed in a line around the periphery of the heat conductive part 3 along the periphery of the shielding part 2. That is, the heat conductive part 3 is passed through by the heat conductive tubes 3C through which the coolant is circulated in the part extending outside the shielding part 2, the part performing heat exchange with the coolant circulating through the coolant circulating unit 54 in order to perform heat exchange by the heat exchanger 52. Consequently, the nuclear reactor 11 of the first embodiment conducts the heat taken out by the heat conductive part 3 to the coolant via the heat conductive tubes 3C. The nuclear reactor 11 of the first embodiment conducts the heat taken out by the heat conductive part 3 indirectly to the coolant by the heat conductive tubes 3C and can thus maintain radiation blocking performance.

In FIG. 7, for example, when the heat conductive part 3 formed extending in the radial direction away from the outer face of the shielding part 2 is divided into two regions in the radial direction by an imaginary line L, the temperature of the heat taken out is higher inside the imaginary line L in the radial direction than outside in the radial direction. Given these circumstances, the heat conductive tubes 3C are placed in the radial direction and include inner heat conductive tubes 3Ca placed inside the imaginary line L in the radial direction and outer heat conductive tubes 3Cb placed outside the imaginary line L in the radial direction. In performing heat exchange with the coolant in the heat conductive part 3, the coolant is first circulated through the outer heat conductive tubes 3Cb and is then returned and circulated through the inner heat conductive tubes 3Ca, and the coolant is then sent out to the heat exchanger 52. In this way, the efficiency of conducting the heat taken out by the heat conductive part 3 to the coolant can be increased.

In the nuclear reactor 11 of the first embodiment, as illustrated in FIG. 8, in the heat conductive part 3, it is preferable that each heat conductive layer 3A is formed in a plate shape by stacking a plurality of plate members 3D on each other in the axial direction overlapping the fuel layer 1A of the fuel part 1. For the heat conductive part 3, graphene can be used, for example. Graphene has a structure in which hexagonal lattices including carbon atoms and their bonding continue and has higher heat conductivity in a direction in which the hexagonal lattices continue. By using this graphene as the sheet-shaped plate members 3D, the hexagonal lattices continue along the faces of the plate members 3D. These plate members 3D are stacked on each other in the axial direction to form a plate shape. The heat conductive part 3 then has higher heat conductivity in the radial direction along the faces of the plate members 3D. Thus, the heat conductive part 3 has higher heat conductivity with respect to the part extending outside the shielding part 2 in the radial direction. Consequently, the nuclear reactor 11 of the first embodiment can increase the efficiency of conducting the heat taken out by the heat conductive part 3 to the coolant.

In the nuclear reactor 11 of the first embodiment, as illustrated in FIG. 9, the fuel layer 1A of the fuel part 1 has a nuclear fuel 1Ab and a covering part 1Ac. The nuclear fuel 1Ab can be formed by sintering uranium powder into a plate shape (a disc shape), for example. The covering part 1Ac is provided so as to cover the entire surface of the nuclear fuel 1Ab. The covering part 1Ac is formed of metal or a carbon compound and holds fission products (FP) discharged by the fission of the nuclear fuel 1Ab so as to prevent their discharge.

Thus, the nuclear reactor 11 of the first embodiment includes the fuel part 1 provided with the covering part 1Ac on the surface of the nuclear fuel 1Ab and the heat conductive part 3 described above. Consequently, the nuclear reactor 11 of the first embodiment can efficiently take heat out of the nuclear fuel 1Ab of the fuel part 1 as the reactor core by the heat conductive part 3 while retaining the fission products.

Specifically, in the nuclear reactor 11 of the first embodiment, the fuel part 1 forms the fuel layer 1A in which the covering part 1Ac is provided on the surface of the nuclear fuel 1Ab formed in a plate shape. The heat conductive part 3 forms the heat conductive layer 3A formed in a plate shape and is provided stacked facing the covering part 1Ac of the fuel layer 1A. That is, the fuel part 1 and the heat conductive part 3 are provided with the heat conductive layer 3A stacked facing the covering part 1Ac of the fuel layer 1A, and the heat conductive part 3 and the fuel part 1 are provided stacked on each other facing the covering part 1Ac. Consequently, the nuclear reactor 11 of the first embodiment can efficiently take heat out of the nuclear fuel 1Ab of the fuel part 1 due to the stacked structure of the fuel layer 1A and the heat conductive layer 3A, which are both formed in a plate shape. The nuclear reactor 11 of the first embodiment forms the fuel layer 1A provided with the covering part 1Ac on the surface of the nuclear fuel 1Ab formed in a plate shape and can thus reduce the surface area on which the covering part 1Ac is provided and improve a fuel filling rate compared to providing a covering part on the surface of many pellet-shaped nuclear fuels. In the fuel layer 1A provided with the covering part 1Ac on the surface of the nuclear fuel 1Ab formed in a plate shape, when the control mechanism 4 is the control rods 4B, the covering part 1Ac is also provided on the inner faces of the holes passing through the control rods 4B.

Specifically, in the nuclear reactor 11 of the first embodiment, as illustrated in FIG. 10 to FIG. 12, in the fuel part 1, the nuclear fuel 1Ab forming the fuel layer 1A is formed as a plurality of block-shaped nuclear fuel components 1B, and the covering part 1Ac is provided on the surface of the nuclear fuel components 1B put together into a plate shape as illustrated in FIG. 9. FIG. 10 illustrates an example in which the block-shaped nuclear fuel components 1B are formed in a rectangular shape and are arranged to enable their ends to be in contact with each other. FIG. 11 illustrates an example in which the block-shaped nuclear fuel components 1B are formed in a triangular shape and are arranged to enable their ends to be in contact with each other. FIG. 12 illustrates an example in which the block-shaped nuclear fuel components 1B are formed in a hexagonal shape and are arranged to enable their ends to be in contact with each other. Thus, in the forms illustrated in FIG. 10 to FIG. 12, the block-shaped nuclear fuel components 1B formed in a flat shape are arranged in a plate shape to form the nuclear fuel 1Ab. Consequently, in the nuclear reactor 11 of the first embodiment, the nuclear fuel 1Ab is formed by the block-shaped nuclear fuel components 1B, which are put together and are provided with the covering part 1Ac, whereby the plate-shaped fuel part 1 as illustrated in FIG. 2 to FIG. 5 and FIG. 9 can be easily produced.

Specifically, in the nuclear reactor 11 of the first embodiment, as illustrated in FIG. 13, the fuel part 1 has a nuclear fuel component 1C provided with the covering part 1Ac on the surface of the nuclear fuel 1Ab formed in a particulate shape. As illustrated in FIG. 14, a plurality of the nuclear fuel components 1C are put together with a heat conductive part 3′ as a base material. For the heat conductive part 3′, titanium, nickel, copper, or graphite can be used, for example. For graphite, graphene in particular can be used. The nuclear fuel component 1C preferably has a diameter of 1 mm, for example, and the covering part 1Ac is preferably ceramic, for example. Consequently, the nuclear reactor 11 of the first embodiment forms the fuel part 1 with the nuclear fuel components 1C put together with the heat conductive part 3′ as a base material and can thereby efficiently take heat out of the nuclear fuel 1Ab of the fuel part 1 as the reactor core by the heat conductive part 3 while retaining the fission products. The nuclear reactor 11 of the first embodiment, in the fuel part 1 illustrated in FIG. 14, can be formed as the plate-shaped fuel layer 1A as illustrated in FIG. 2 to FIG. 5. The nuclear reactor 11 of the first embodiment, in the fuel part 1 illustrated in FIG. 14, can be formed as the block-shaped nuclear fuel component 1B as illustrated in FIG. 10 to FIG. 12, with the covering part 1Ac on the surface omitted. The nuclear reactor 11 of the first embodiment, in the fuel part 1 illustrated in FIG. 14, can be formed as the plate-shaped fuel layer 1A as illustrated in FIG. 2, with the plate-shaped heat conductive parts 3 (the heat conductive layers 3A) provided stacked on each other. That is, the fuel part 1 with the nuclear fuel components 1C put together with the heat conductive part 3′ as a base material and another heat conductive part different from the heat conductive part 3′ (the heat conductive part 3 (the heat conductive layer 3A)) are both formed in a plate shape and are provided stacked on each other. With this configuration, the effect of efficiently taking heat out of the nuclear fuel 1Ab of the fuel part 1 as the reactor core can be obtained markedly. The nuclear reactor 11 of the first embodiment may form a plate-shaped fuel layer in the fuel part 1 illustrated in FIG. 14 and include only a plurality of the fuel layers stacked on each other without having the heat conductive part separate from the heat conductive part 3′.

Specifically, in the nuclear reactor 11 of the first embodiment, the heat conductive part 3 (the heat conductive layer 3A) conducts the heat of the fuel part 1 to the outside by solid heat conduction. Consequently, the nuclear reactor 11 of the first embodiment can take out heat while preventing radiation leakage and can ensure high output temperature.

In the configuration of the nuclear reactor 11 of the first embodiment, the fuel part 1 has a higher temperature in the central part than in the peripheral part when the placement density of the nuclear fuels 1Ab is made even. The nuclear reactor 11 of the first embodiment is configured to take out heat to the peripheral side, which is the radial direction of the fuel part 1, and in order to take out heat easily, the temperature distribution of the nuclear fuels 1Ab is preferably made even. Thus, in the nuclear reactor 11 of the first embodiment, in the fuel part 1, the placement density of the nuclear fuels 1Ab is made lower in the central part than in the peripheral part, whereby the temperature distribution of the fuel part 1 is made even, and heat can be taken out easily.

### Second Embodiment

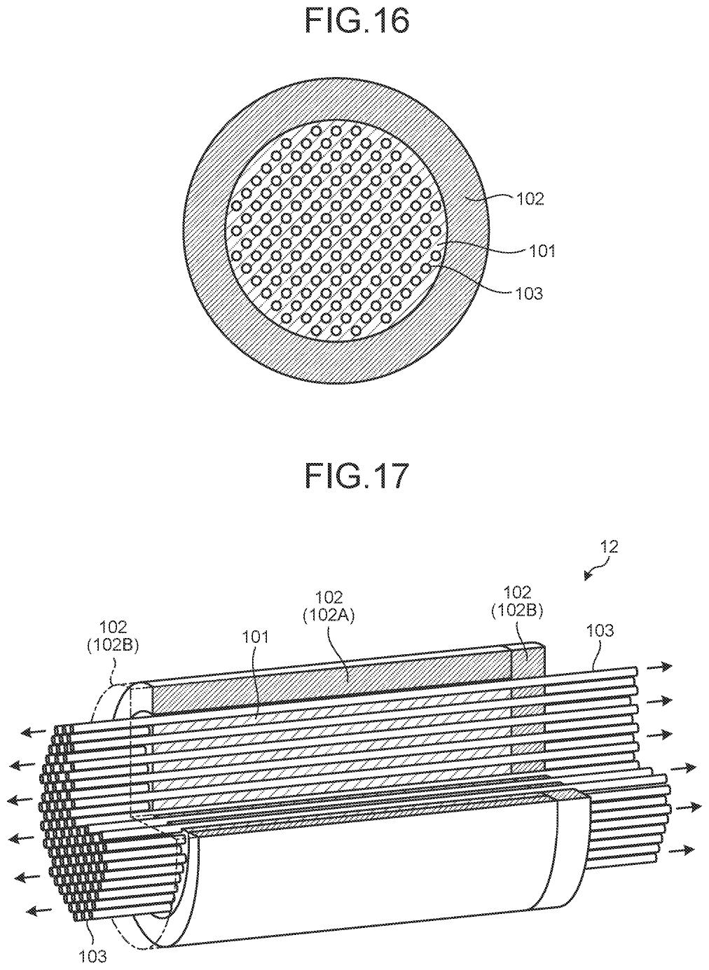

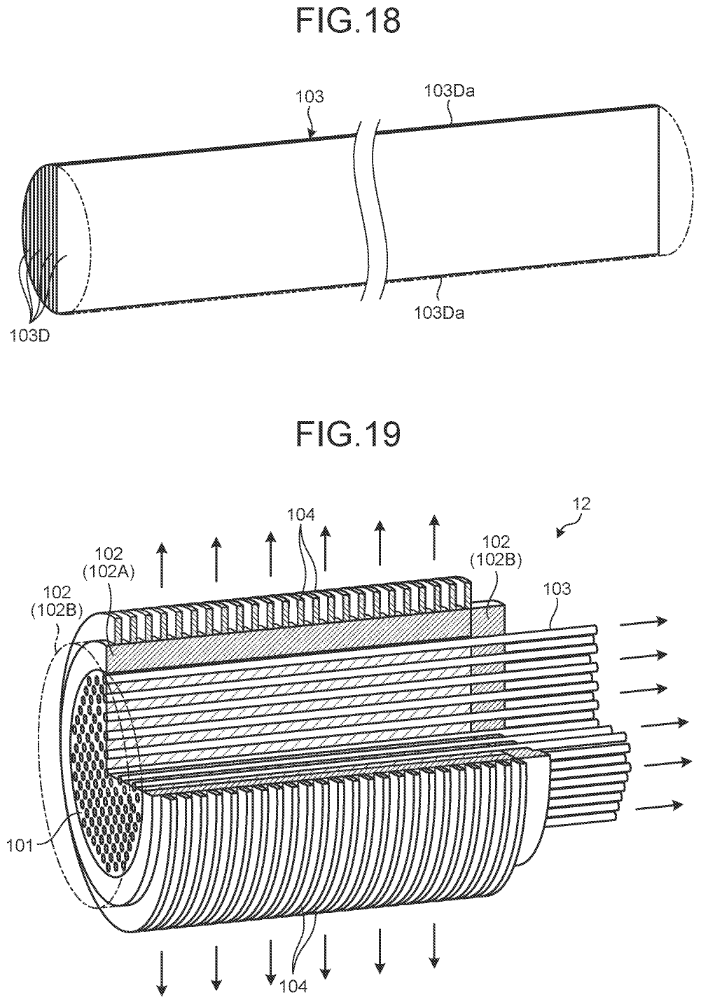

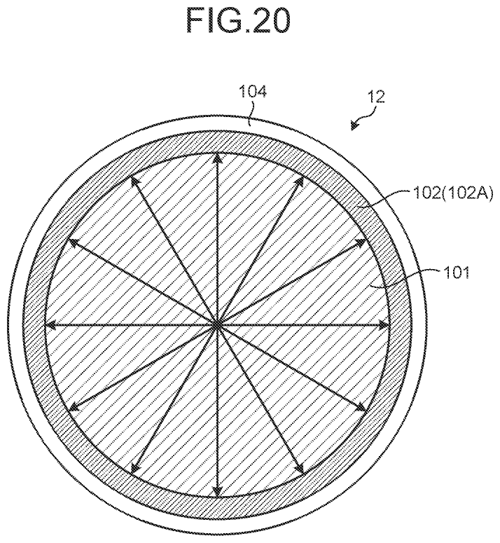

FIG. 15 is a schematic diagram of a nuclear reactor according to a second embodiment. FIG. 16 is a sectional schematic diagram of the nuclear reactor according to the second embodiment. FIG. 17 is a schematic diagram of another form of the nuclear reactor according to the second embodiment. FIG. 18 is an enlarged schematic diagram of a heat conductive part of the nuclear reactor according to the second embodiment. FIG. 19 is a schematic diagram of another form of the nuclear reactor according to the second embodiment. FIG. 20 is an illustrative diagram of the form illustrated in FIG. 18.

As illustrated in FIG. 15 and FIG. 16, this nuclear reactor 12 includes a fuel part (a reactor core) 101, a shielding part 102, and the heat conductive parts 103. The nuclear reactor 12 also includes the control mechanism 4 described in the first embodiment, although not explicitly illustrated in the drawing.

The fuel part 101 is formed in a columnar shape as a whole. In the second embodiment, the fuel part 101 is formed in a substantially cylindrical shape. The direction in which this columnar shape extends may be referred to as an axial direction. The direction orthogonal to the axial direction may be referred to as a radial direction. The fuel part 101 contains uranium as nuclear fuel.

The shielding part 102 covers the periphery of the fuel part 101. The shielding part 102 includes a metallic block and reflects radiation (neutrons) applied from the nuclear fuel to prevent the radiation from being leaked to the outside covering the fuel part 101. The shielding part 102 may be called a reflector in accordance with the ability of neutron scattering and neutron absorption of the used material.

The shielding part 102 in the second embodiment includes a body 102A formed in a tubular shape so as to surround the entire periphery of the columnar shape on the fuel part 101 and respective lids 102B plugging both ends of the body 102A. In housing the fuel part 101 inside, it is preferable that the inside of the shielding part 102 with the hermetically sealed structure be filled with an inert gas such as a nitrogen gas for the purpose of preventing oxidation inside.

The heat conductive parts 103 are formed in a rod shape extending in the axial direction. The heat conductive parts 103 pass through the shielding part 102 and are inserted into the fuel part 101 covered by the shielding part 102 to be placed extending inside the fuel part 101 and outside the shielding part 102. The heat conductive parts 103 conduct the heat generated by the nuclear fission reaction of the nuclear fuel of the fuel part 101 to the outside of the shielding part 102 by solid heat conduction. For the heat conductive parts 103, titanium, nickel, copper, or graphite can be used, for example. For graphite, graphene in particular can be used. The part of the heat conductive parts 103 extending outside the shielding part 102 is provided so as to be able to perform heat exchange with the coolant inside the nuclear reactor vessel 51.

The control mechanism 4 can be configured as the control drums 4A illustrated in FIG. 3 described in the first embodiment. The control drums 4A are placed in the shielding part 102. The detailed configuration of the control drums 4A is described in the first embodiment, and a description thereof is omitted here. The control mechanism 4 can be configured as the control rods 4B illustrated in FIG. 4 described in the first embodiment. The control rods 4B are placed extending in the axial direction parallel to the heat conductive parts 103 in the fuel part 1. The detailed configuration of the control rods 4B is described in the first embodiment, and a description thereof is omitted here.

Consequently, the nuclear reactor 12 of the second embodiment can take the heat generated by the nuclear fission reaction of the nuclear fuel of the fuel part 101 out of the shielding part 2 by solid heat conduction by the heat conductive parts 103. The heat having been taken out of the shielding part 102 is then conducted to the coolant, which rotates the turbine 55.

The nuclear reactor 12 of the second embodiment can take the heat of the nuclear fuel of the fuel part 101 out of the shielding part 102 by solid heat conduction by the heat conductive parts 103 (refer to the arrows in FIG. 15) and conduct the heat to the coolant. Consequently, the nuclear reactor 12 of the second embodiment can prevent leakage of radioactive materials or the like. In the nuclear reactor 12 of the second embodiment, the heat conductive parts 103 are placed extending inside the fuel part 101 and outside the shielding part 102 and can thus take the heat of the nuclear fuel of the fuel part 101 out of the shielding part 102 while reducing the conduction distance of the heat. Consequently, the nuclear reactor 12 of the second embodiment can ensure high output temperature. Although the nuclear reactor 12 of the second embodiment describes the heat conductive parts 103 in the form of taking out heat by solid heat conduction, other heat conductive parts in the form of taking out heat by fluid heat conduction using a liquid-encapsulated heat pipe may be used, for example.

In the nuclear reactor 12 of the second embodiment, as illustrated in FIG. 17, the heat conductive parts 103 may be placed passing through the fuel part 101 and extending outside the shielding part 102 on the opposite sides in the axial direction. That is, in the nuclear reactor 12 illustrated in FIG. 17, the heat conductive parts 103 pass through both lids 102B of the shielding part 102 to extend in the axial direction and are placed outside the shielding part 102 on the opposite sides. Consequently, the nuclear reactor 12 of the second embodiment can take the heat of the fuel part 101 outside the shielding part 102 on the opposite sides by solid heat conduction (refer to the arrows in FIG. 17).

In the nuclear reactor 12 of the second embodiment, as illustrated in FIG. 18, the heat conductive part 103 is preferably formed in a rod shape by stacking plate members 103D continuous in the extension direction of the rod shape on each other. For the heat conductive part 103, graphene can be used, for example. Graphene has a structure in which hexagonal lattices including carbon atoms and their bonding continue and has higher heat conductivity in a direction in which the hexagonal lattices continue. By using this graphene as the sheet-shaped plate members 103D, the hexagonal lattices continue along the faces of the plate members 103D. These plate members 103D are stacked on each other to form a rod shape. The heat conductive part 103 then has higher heat conductivity in the axial direction as the extension direction of the rod shape along the faces of the plate members 103D. Thus, the heat conductive parts 103 have higher heat conductivity with respect to the part extending outside the shielding part 102 in the axial direction. Consequently, the nuclear reactor 12 of the second embodiment can increase the efficiency of conducting the heat taken out by the heat conductive parts 103 to the coolant.

As illustrated in FIG. 19 and FIG. 20, the nuclear reactor 12 of the second embodiment may include other heat conductive parts 104 mounted outside the shielding part 102 from which the heat conductive parts 103 are not extended. In the second embodiment, the shielding part 102 from which the heat conductive parts 103 are not extended is the body 102A, and the other heat conductive parts 104 are mounted outside this body 102A. As illustrated in FIG. 19 and FIG. 20, the other heat conductive parts 104 are formed in a ring shape surrounding the body 102A of the shielding part 102 and are mounted side by side in the axial direction. Although not explicitly illustrated in the drawing, the other heat conductive parts 104 may be formed in a plate shape extending in the axial direction and be mounted side by side so as to surround the body 102A of the shielding part 102. For the other heat conductive parts 104, titanium, nickel, copper, or graphite can be used, for example. For graphite, graphene in particular can be used. By providing the other heat conductive parts 104, heat can also be taken out of the outside of the shielding part 102 from which the heat conductive parts 103 are not extended (refer to the arrows in FIG. 19). As described with reference to FIG. 6 and FIG. 7 in the first embodiment, in performing heat exchange with the coolant for the heat taken out by the other heat conductive parts 104, the coolant is first passed outside in the radial direction and is then returned and passed inside in the radial direction, and the coolant is sent out to the heat exchanger 52.

In the nuclear reactor 12 of the second embodiment, the heat conductive parts 103, in the form in which the plate members 103D continuous in the extension direction of the rod shape are stacked on each other to be formed in a rod shape, may be placed with ends 103Da of the plate members 103D forming the peripheral face of the rod shape directed toward the other heat conductive parts 104 mounted on the outside of the shielding part 102. In the heat conductive part 103 formed in a rod shape by overlapping the faces of the plate members 103D continuous in the extension direction of the rod shape as illustrated in FIG. 18, the ends 103Da of the plate members 103D forming the peripheral face of the rod shape are directed in opposite directions along the faces of the plate members 103D. The ends 103Da of the plate members 103D forming the peripheral face of the rod shape are placed directed toward the other heat conductive parts 104 mounted on the outside of the shielding part 102 as indicated by the arrows in FIG. 20. As described above, the heat conductive part 103 has higher heat conductivity along the faces of the plate members 103D. Consequently, by directing the ends 103Da directed in opposite directions along the faces of the plate members 103D toward the other heat conductive parts 104, heat conductivity to the other heat conductive parts 104 increases. Consequently, the nuclear reactor 12 of the second embodiment can efficiently take out the heat taken out by the heat conductive parts 103 by the other heat conductive parts 104 and thus increase the efficiency of conducting it to the coolant.

In the nuclear reactor 12 of the second embodiment, the fuel part 101 has nuclear fuel and a covering part like the fuel part 1 of the first embodiment, although not explicitly illustrated in the drawing. The nuclear fuel can be formed by sintering uranium powder into a columnar shape (a cylindrical shape), for example. The covering part is provided so as to cover the entire surface of the nuclear fuel. The covering part is formed of metal or a carbon compound and holds the fission products (FP) discharged by the fission of the nuclear fuel so as to prevent their discharge.

Thus, the nuclear reactor 12 of the second embodiment includes the fuel part 101 provided with the covering part on the surface of the nuclear fuel and the heat conductive parts 103 described above. Consequently, the nuclear reactor 12 of the second embodiment can efficiently take heat out of the nuclear fuel of the fuel part 1 as the reactor core by the heat conductive parts 103 while retaining the fission products. The nuclear reactor 12 of the second embodiment forms the fuel part 1 provided with the covering part on the surface of the nuclear fuel formed in a columnar shape and can thereby reduce the surface area on which the covering part is provided and improve a fuel filling rate compared to providing the covering part on the surface of many pellet-shaped nuclear fuels. In the fuel part 1 provided with the covering part on the surface of the nuclear fuel formed in a columnar shape, when the control mechanism 4 is the control rods 4B, the covering part is also provided on the inner faces of the holes passing through the control rods 4B.

In the nuclear reactor 12 of the second embodiment, in the fuel part 101, the nuclear fuel may be configured as a plurality of block-shaped nuclear fuel components, and a covering part may be provided on the surface of the nuclear fuel components put together into a columnar shape like the fuel part 1 of the first embodiment, although not explicitly illustrated in the drawing. Consequently, in the nuclear reactor 12 of the second embodiment, the nuclear fuel is formed by the block-shaped nuclear fuel components, which are put together and are provided with the covering part, whereby the columnar fuel part 101 as one body can be easily produced.

In the nuclear reactor 12 of the second embodiment, the fuel part 101 may have a nuclear fuel component provided with a covering part on the surface of nuclear fuel formed in a particulate shape, and a plurality of the nuclear fuel components may be put together with a heat conductive part as a base material like the fuel part 1 of the first embodiment, although not explicitly illustrated in the drawing. Consequently, the nuclear reactor 12 of the second embodiment forms the fuel part 101 with the nuclear fuel components put together with the heat conductive part as a base material and can thereby efficiently take heat out of the nuclear fuel of the fuel part 101 as the reactor core by the heat conductive part while retaining the fission products. The nuclear reactor 12 of the second embodiment, in the fuel part 101 with the nuclear fuel components put together with the heat conductive part as a base material, can be formed as block-shaped nuclear fuel components with the covering part on the surface omitted. In addition, the nuclear reactor 12 of the second embodiment, in the fuel part 101 with the nuclear fuel components put together with the heat conductive part as a base material, has a configuration in which the heat conductive parts 103 described above formed in a rod shape are provided and can thereby markedly obtain the effect of efficiently taking heat out of the nuclear fuel of the fuel part 101 as the reactor core.

In the nuclear reactor 12 of the second embodiment, the heat conductive parts 103 conduct the heat of the fuel part 101 to the outside by solid heat conduction. Consequently, the nuclear reactor 12 of the second embodiment conducts the heat of the fuel part 101 to the outside by solid heat conduction and can thereby take out heat while preventing radiation leakage and can ensure high output temperature.

In the nuclear reactor 12 of the second embodiment, as described above, the heat conductive parts 103 are formed in a rod shape to extend in the fuel part 101 in the axial direction and are placed passing through the lids 102B of the shielding part 102. In this configuration, the heat taken out has a higher temperature in the central part than in the peripheral part when the placement density of the fuel part 101 is made even. Thus, in performing heat exchange with the coolant in the heat conductive parts 103, the coolant is first passed through the part of the heat conductive parts 103 outside in the radial direction and is then passed through the part of the heat conductive parts 103 inside in the radial direction, and the coolant is then sent out to the heat exchanger 52. In this way, the efficiency of conducting the heat taken out by the heat conductive parts 103 to the coolant can be increased. When the placement density of the fuel part 101 is made even, the temperature is higher in the central part than in the peripheral part, and the area is smaller in the central part, in which the efficiency of taking out heat reduces, and thus in order to increase the density of the heat conductive parts 103 in the central part, the rod-shaped heat conductive parts 103 may be thicker or their placement intervals may be closer in the central part of the fuel part 101. When the placement density of the fuel part 101 is increased in the peripheral part of the fuel part 101, having a larger area, the efficiency of taking out heat in the part having a larger area can be increased. In this case, in order to increase the density of the heat conductive parts 103 in the peripheral part of the fuel part 101, the rod-shaped heat conductive parts 103 may be thicker or their placement intervals may be closer in the peripheral part of the fuel part 101.

### Third Embodiment

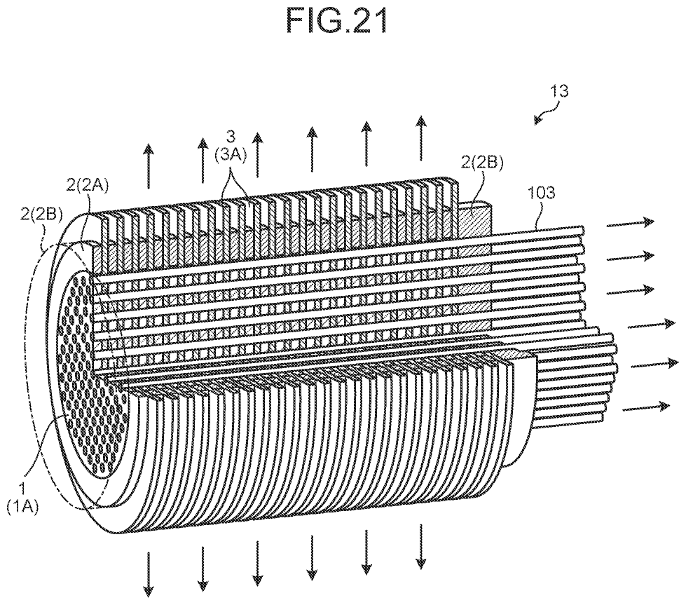

FIG. 21 is a schematic diagram of a nuclear reactor according to a third embodiment.

This nuclear reactor 13 of the third embodiment combines the configuration of the nuclear reactor 11 of the first embodiment and the configuration of the nuclear reactor 12 of the second embodiment described above with each other. Thus, the same components as the components of the nuclear reactor 11 and the nuclear reactor 12 are denoted by the same symbols, and descriptions thereof are omitted.

The nuclear reactor 13 of the third embodiment includes the fuel part 1 of the nuclear reactor 11, the shielding part 2, and the heat conductive parts (first heat conductive parts) 3 of the first embodiment, and the heat conductive parts (second heat conductive parts) 103 of the nuclear reactor 12 of the second embodiment. The nuclear reactor 13 includes the control mechanism 4 (the control drums 4A or the control rods 4B) described in the first embodiment, although not explicitly illustrated in the drawing.

That is, the nuclear reactor 13 is formed with holes into which the heat conductive parts 103 are inserted in the fuel layers 1A of the fuel part 1 and the heat conductive layers 3A of the heat conductive parts 3.

In the nuclear reactor 13 of the third embodiment, the heat conductive part includes the first heat conductive parts 3 formed in a plate shape and placed stacked on the fuel layers 1A and the second heat conductive parts 103 formed in a rod shape and placed extending in the axial direction in which the fuel layers 1A and the first heat conductive parts 3 overlap. Consequently, the nuclear reactor 13 of the third embodiment can be a form in which the first heat conductive parts 3 and the second heat conductive parts 103 are placed passing through the shielding part 2 and extending inside the fuel part 1 and outside the shielding part 2, and the heat of the fuel part 1 can be taken out of the shielding part 2 by solid heat conduction.

The nuclear reactor 13 of the third embodiment can produce the same effects as those of the first embodiment and the second embodiment due to the same configuration as those of the nuclear reactor 11 of the first embodiment and the nuclear reactor 12 of the second embodiment described above.

### REFERENCE SIGNS LIST

1 Fuel part
1A Fuel layer
1Aa Peripheral face
1Ab Nuclear fuel
1Ac Covering part
1B Nuclear fuel component
1C Nuclear fuel component
2 Shielding part
2A Shielding layer
2Aa Through hole
2B Lid
3 Heat conductive part (first heat conductive part)
3A Heat conductive layer
3B Cutout
3C Heat conductive tube
3Ca Inner heat conductive tube
3Cb Outer heat conductive tube
3D Plate member
4 Control mechanism
4A Control drum
4Aa Neutron absorber
4B Control rod
11, 12, 13 Nuclear reactor
50 Nuclear power generation system
51 Nuclear reactor vessel
52 Heat exchanger
53 Heat conductive part
54 Coolant circulating unit
55 Turbine
56 Power generator
57 Cooler
58 Compressor
101 Fuel part
102 Shielding part
102A Body
102B Lid
103 Heat conductive part (second heat conductive part)
103D Plate member
103Da End
104 Heat conductive part

1. A nuclear reactor comprising:
a fuel part provided with a covering part on a surface of a nuclear fuel; and
a heat conductive part.

2. The nuclear reactor according to claim 1, wherein the heat conductive part and the fuel part are provided stacked on each other facing the covering part.

3. The nuclear reactor according to claim 1, wherein in the fuel part, the nuclear fuel includes a plurality of block-shaped nuclear fuel components, and the covering part is provided on a surface of the block-shaped nuclear fuel components put together.

4. A nuclear reactor comprising a fuel part having a plurality of nuclear fuel components each provided with a covering part on a surface of a nuclear fuel formed in a particulate shape, the nuclear fuel components being put together with a heat conductive part as a base material.

5. The nuclear reactor according to claim 4, wherein the fuel part and another heat conductive part are both formed in a plate shape and are provided stacked on each other.

6. The nuclear reactor according to claim 1, wherein the heat conductive part conducts heat of the fuel part to the outside by solid heat conduction.

7. The nuclear reactor according to claim 4, wherein the heat conductive part conducts heat of the fuel part to the outside by solid heat conduction.
